(19) United States
(12) Patent Application Publication
(10) Pub. No.: US 2002/0011916 A1
(43) Pub. Date: Jan. 31, 2002

(54) Fuseholder remover

(76) Inventor: Robert B. Fennell, Springfield, GA (US)

Correspondence Address: Law Office of Jim Zegeer, Suite 108, 801 North Pitt Street, Alexandria, VA, 22314, US

(21) Appl. No.: 09/742,297

(22) Filed: Dec. 22, 2000

Related U.S. Application Data
(60) Provisional application No. 60/173,498, filed on Dec. 29, 1999.

(51) Int. Cl. H01H 71/10

(52) U.S. Cl. 337/171

(57) ABSTRACT

A hot stick switch head for a lineman's tool for safely and expeditiously removing and installing fuseholders having a tubular body and a mounting assembly from an overhead mounting comprising a base member having a downwardly depending attachment device for attachment to the end of a hot stick and an elevated slot member on the opposite end thereof for receiving an element of said mounting assembly, and a fusebody-receiving notch. A laterally projecting arm engages a fusebody anywhere along the length thereof an guides the fusebody into the fusebody-receiving notch in the base member. The notch and slot are shaped and juxtaposed relative to each other so that on vertical elevation of the lineman's tool, the fusebody is securely retained thereon while the fusebody is lifted out of the fusebody mounting.

### REFERENCE TO RELATED APPLICATION

The present application is the subject of my provisional application Serial No. 60/173,498 filed Dec. 29, 1999 entitled FUSEHOLDER REMOVER.

### BACKGROUND AND BRIEF DESCRIPTION OF THE INVENTION

In my Pat. Nos. 5,532,668 and 5,670,927 I disclose universal fuseholders and cutouts with built-in safety features in which a slot having a length L and a width W for engagement by the projecting arm of a lineman's hot stick switch enables safe and expedient fuseholder maintenance, particularly in high wind and strong conditions. In my Pat. No. 5,532,668 I provide an attachment for an adaptor which is adapted to be secured to a fuse tube with a slot for engagement of the projecting arm of a hot stick switch.

In my present invention, instead of providing a slot on the fusebody either by way of an attachment or by the cut-out switch construction itself, I have modified the hot stick switch head by providing a slot and notch on the hot stick switch head which enable easy use of the hot stick switch to safely remove fuseholders for servicing and replacement of fuseholders without injury to the alignment or line repair.

The invention is directed to a hot stick switch head for a lineman's tool for safely and expeditiously removing and installing fuseholders having a tubular body and a mounting assembly from an overhead mounting comprising a base member having a downwardly depending attachment swivel device and an elongated slot on the opposite end thereof for receiving an element of the mounting assembly, and a fusebody-receiving notch. The invention includes a laterally projecting arm for engaging a fusebody anywhere along the length thereof and guiding said fusebody into said fusebody-receiving notch in said base member. The notch and slot are shaped and juxtapositioned so that on vertical elevation of the lineman's tool, the fusebody is securely retained while the fusebody is lifted out of or lifted to the fusebody mounting.

Thus, the object of the invention is to provide an improved fuseholder remover system and method which is low in cost and does not require any modification or change to the fuseholder and is adaptable to a wide variety of manufactured fuseholders.

### BRIEF DESCRIPTION OF THE DRAWINGS

The above and other objects, advantages and features of the invention will become more apparent when considered with the following specification and accompanying drawings wherein:

FIG. 1A is a side elevational view of the current tool head with projecting arm PA for use on a hot stick switch. It is very easy for the fuseholder to fall off the disconnect tool and injure the lineman or repair person,

FIG. 1B is a view from my Pat. No. 5,532,668 which depicts a canted hook slot,

FIG. 2 is a perspective elevational view of the preferred embodiment of the lineman's hot stick switch head incorporating the present invention,

FIG. 3 is a top plan view of the embodiment shown in FIG. 2,

FIG. 4 is an end view of the embodiment shown in FIGS. 2 and 3,

FIG. 5 is a side elevational view showing the projecting arm of the hot stick switch and new head assembly incorporating the invention and its easy and facile use in safely engaging and removing and replacing a above-ground distribution fuse cut-out switch,

FIGS. 6A-6F illustrate a preferred embodiment of the invention,

FIG. 7 is a perspective elevational view of a further embodiment of the invention,

FIG. 8 is a perspective elevational view of a less preferred embodiment of the invention.

### DESCRIPTION OF THE INVENTION

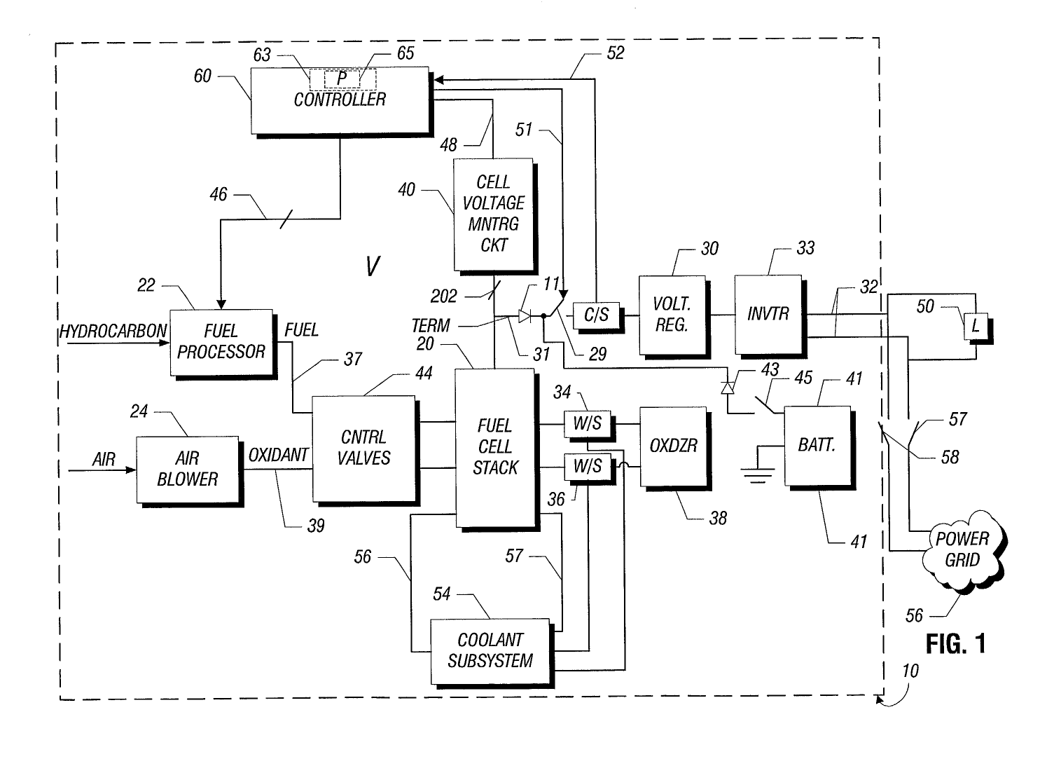

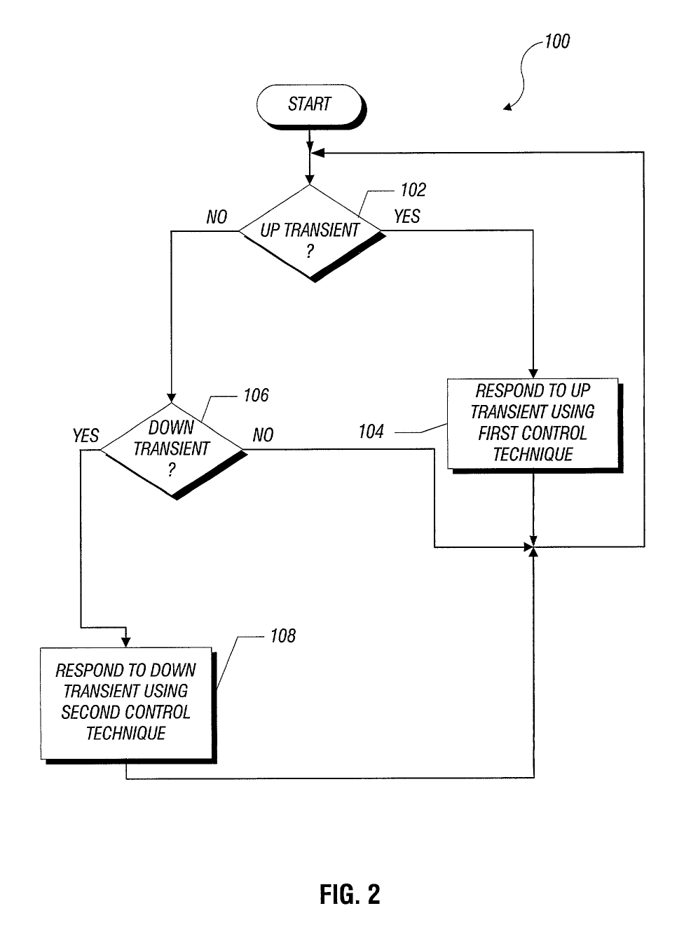

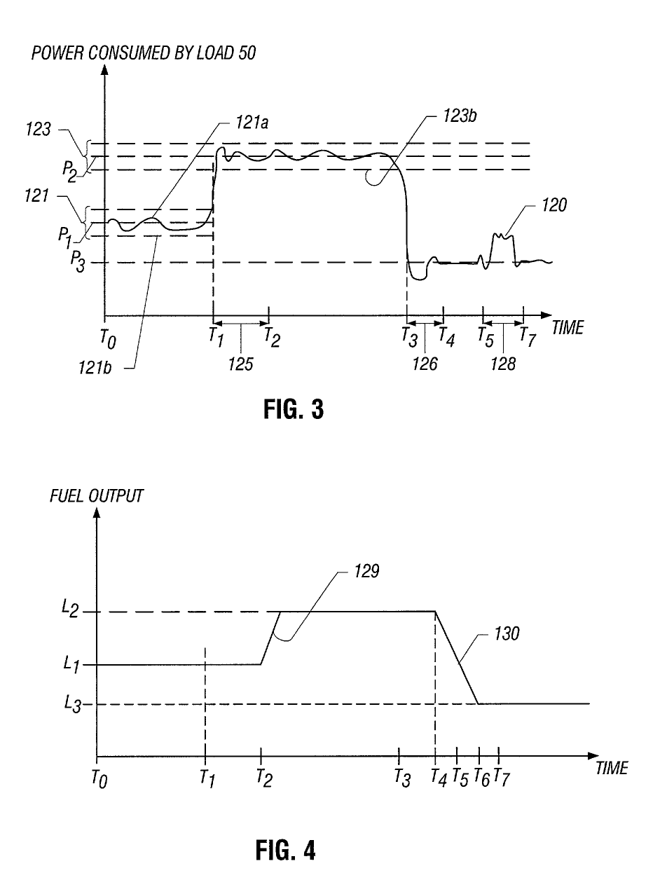

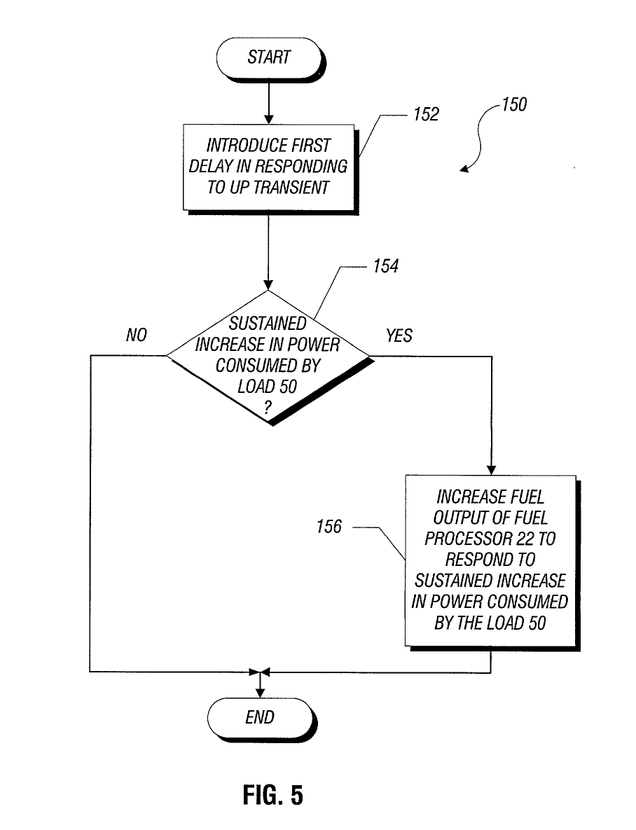

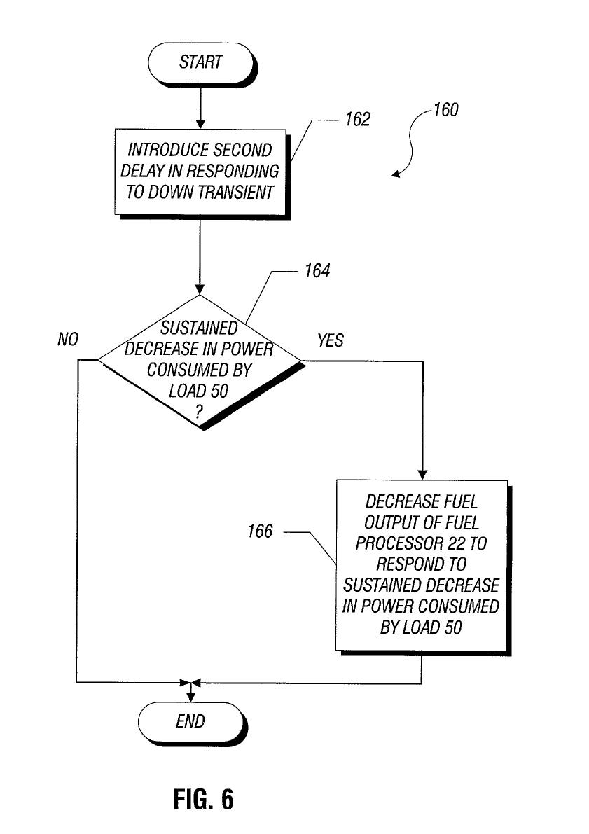

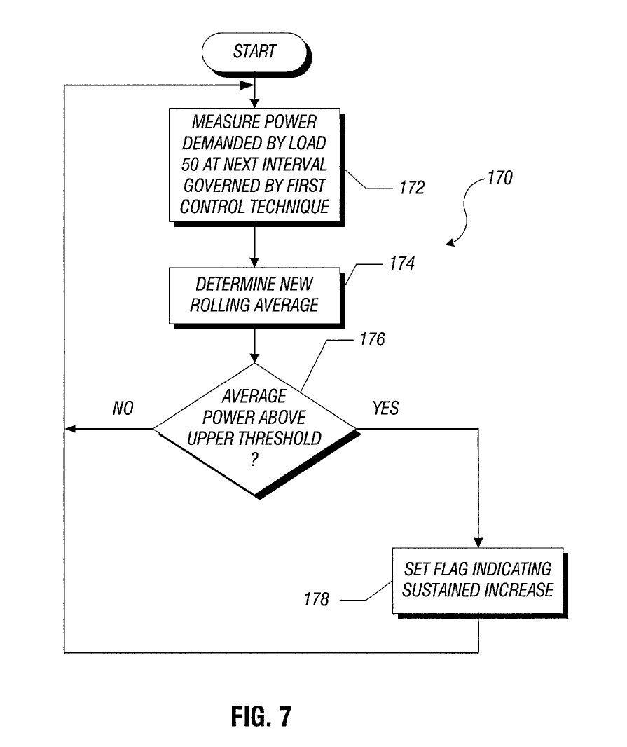

Referring to FIGS. 2, 3, 4 and 5, the hot stick switch head of a lineman's tool incorporating the invention has a base member 10 having a downwardly depending attachment swivel head 11 and an elongated V-slot member 12. Laterally projecting arm 13 has attached thereto a projecting arm 14 of a hot stick switch. Formed with the body of the head is a loop member 15 which forms a notch 15N for receiving the tubular fuse body FB, as shown in FIG. 3, in conjunction with V-slot member 12, is used to latch the fuse cut-out switch to the hot stick switch head. The V-slot member 12 is juxtaposed at an angle relative to notch 15N and projects upwardly to engage the clevis of the fusebody trunnion mechanism. In use, the projecting arm 14 is used to strike or engage the fusebody FB anywhere along the length of fusebody FB as indicated in FIG. 3. Thus, this avoids the necessity of the lineman on the ground having to fit the projecting arm of the conventional hot stick switch projecting arm PA (see FIG. 1) into trunnion portions of the fuse cut-out switch. He is provided with a much larger and more visible target, namely, the length of the fusebody itself in which to engage the fuse cut-out switch from twenty to thirty feet or more below on the ground. As indicated in the first dotted circle of FIG. 3, the fusebody is engaged by the projecting arm 14, and then the projecting arm 14 is used as a guide to guide the head 10 around the fusebody so that the fusebody is positioned in the solid line position as shown in FIG. 3. Then the head is moved vertically in the direction of the arrow by the lineman from below the ground so as to engage the long slot 12 with the clevis of the fusebody trunnion mechanism and lift the trunnions out of the trunnion sockets (not shown) and lower the fusebody to the ground. Due to the engagement of the slot 12 with a portion of the trunnion clevis and the engagement of the curved arm loop member or notch 15N about the fusebody, there is no possibility for the fuse cut-out switch to fall off of the head during raising or lowering of the fuse cut-out switch to the ground by the lineman.

It will be noted that in this preferred embodiment the projecting arm is offset laterally from the attachment portion of the head for attachment to the lineman's hot stick switch. The offset attends to the angle of the fusebody as it hangs in the trunnion sockets above ground.

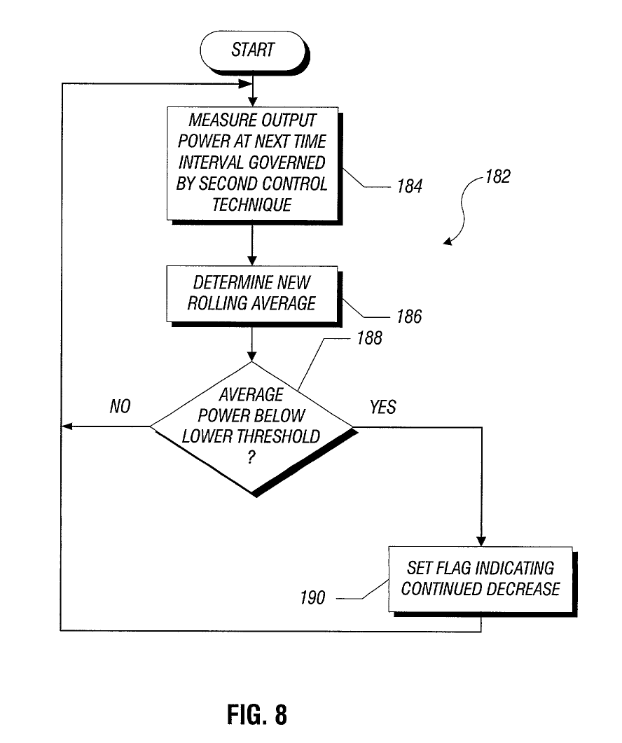

In the preferred embodiment shown in FIGS. 6A-6F, the construction is essentially the same as shown in FIGS. 2, 3, 4 and 5 except that the parts are rearranged slightly for better manufacturability. While there is a three-part assembly shown in FIGS. 6A-6F (arm 14′ is threadably joined to the notch member 15N′), they could be cast or molded as an integral unit, either as a casting (preferably aluminum alloy for light weight) as a fiberglass or other plastic components.

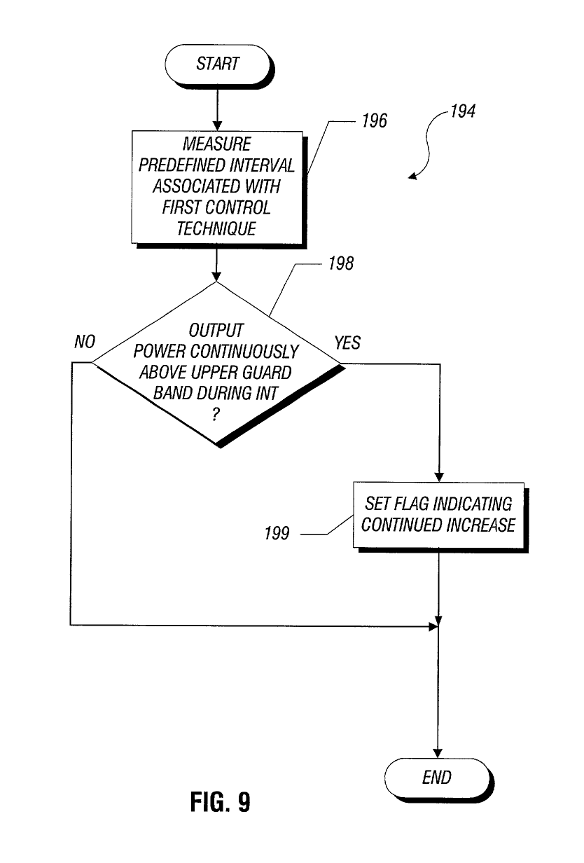

The same offset concept is illustrated in FIG. 7 except in this embodiment, the projecting arms of the fusebody engaging component of the improved head engages the fusebody in a slightly different manner. It must be engaged directly from the ground, but it can be used to engage with the diverging fingers or arms to engage the head much more easily than engaging the eye by the projecting arm of the conventional lineman's switch stick.

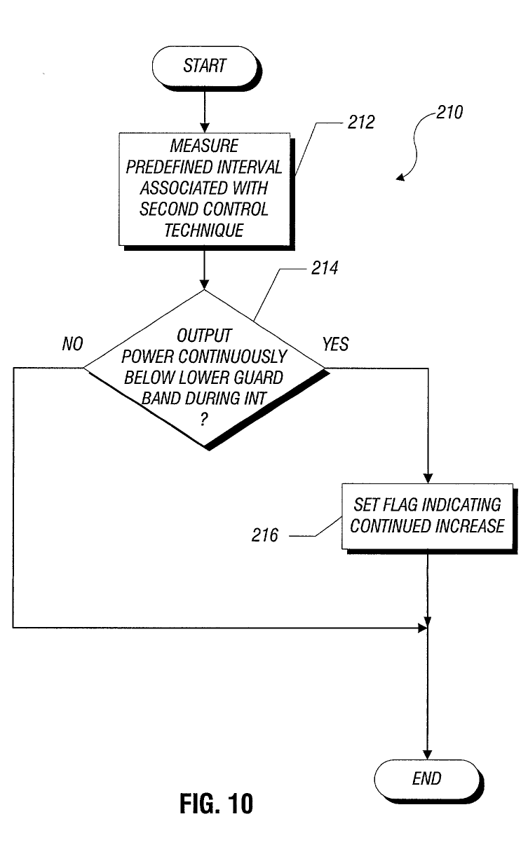

In the embodiment shown in FIG. 8, which is the least preferred embodiment, there is no offset of the fusebody engaging portion from the lineman's stick mounting member.

The fuseholder remover disclosed herein will remove all types of fuseholders (even old-type fuseholders). New-type fuseholders are taken out with the fork slot and fuseholder body. The new fuseholder remover will hook the fuseholder so that it does not fall off. The invention also provides an improved disconnect tool for the use on new type fuseholders, making it much safer to utilize.

The stick latch or mounting head rotates to align the button on the fiberglass stick and also rotates to avoid the wing nut from interfering with removal of the fuseholder.

The new fuseholder remover of this invention makes removing fuses faster and safer in rain and wind. The disconnect tool also acts as a guide as it guides the fuseholder into the fuseholder remover.

While the invention has been described in relation to preferred embodiments of the invention, it will be appreciated that other embodiments, adaptations and modifications of the invention will be apparent to those skilled in the art.

What is claimed is:

1. A hot stick switch head for a lineman's tool for safely and expeditiously removing and installing fuseholders having a tubular body and a mounting assembly from an overhead mounting comprising:
a base member having a downwwardly depending attachment device for attachment to an end of a hot stick and a slot member on the opposite end thereof for receiving an element of said mounting assembly, and a fusebody-receiving notch,
a laterally projecting arm for engaging a fusebody anywhere along the length thereof and guiding said fusebody into said fusebody-receiving notch in said base member, said notch and slot being shaped and juxtaposed relative to each other so that on vertical elevation of said lineman's tool, said fusebody is securely retained while said fusebody is lifted out of said fusebody mounting.

2. The hot stick switch head defined in claim 1 wherein said attachment device is offset from said fusebody-receiving notch.

3. The hot stick switch head defined in claim 1 wherein said slot has a diverging mouth for orienting said elements into said slot.

4. A hot stick switch head for a lineman's tool for safely and expeditiously removing and installing fuseholders having a tubular body and a mounting assembly from an overhead mounting comprising:
a base member having a downwwardly depending attachment swivel device for attachment to an end of said hot stick and an elongated slot having a diverging mouth on the opposite end thereof for receiving an element of said mounting assembly, and a fusebody-receiving notch,
a laterally projecting arm for engaging a fusebody anywhere along the length thereof and guiding said fusebody into said fusebody-receiving notch in said base member, said notch and slot being shaped and juxtaposed relative to each other so that on vertical elevation of said lineman's tool, said fusebody is securely retained while said fusebody is lifted out of said fusebody mounting.
